(19) United States
(12) Patent Application Publication
(10) Pub. No.: US 2019/0190060 A1
(43) Pub. Date: Jun. 20, 2019

(54) ELECTROCHEMICAL CELLS

(71) Applicant: 3M INNOVATIVE PROPERTIES COMPANY, St. Paul, MN (US)

(72) Inventors: Vincent J.L. Chevrier, St. Paul, MN (US); Larry J. Krause, Stillwater, MN (US); Lowell D. Jensen, Stillwater, MN (US)

(21) Appl. No.: 16/221,654

(22) Filed: Dec. 17, 2018

Related U.S. Application Data
(60) Provisional application No. 62/607,411, filed on Dec. 19, 2017.

(51) Int. Cl. H01M 10/0525; H01M 10/058; H01M 4/131; H01M 4/134; H01M 4/38; H01M 4/525

(52) U.S. Cl. CPC H01M 10/0525; H01M 10/058; H01M 4/131; H01M 2004/021; H01M 4/386; H01M 4/525; H01M 4/134

(57) ABSTRACT

An electrochemical cell includes a negative electrode that includes an active material including silicon. The electrochemical cell further includes a positive electrode that includes a first lithium metal oxide and a second lithium metal oxide. The first lithium metal oxide includes a material having (i) a nickel content of less than 30 mole %, based on the total moles of non-lithium metals in the first lithium metal oxide; and (ii) a D50 of greater than 2 micrometers. The second lithium metal oxide includes a material having (i) a nickel content of greater than 30 mole %, based on the total moles of non-lithium metals in the first lithium metal oxide; and (ii) a D50 of less than 2 micrometers. The second lithium metal oxide is provided in the positive electrode composition in an amount of less than 20 wt. %, based on the total weight of the first lithium metal oxide and second lithium metal oxide in the positive electrode composition.

### FIELD

The present disclosure relates to electrochemical cells.

### BACKGROUND

Various cathode and anode compositions have been introduced for use in electrochemical cells. Such compositions are described, for example, in T. Ohzuku and R. J. Brodd, Journal of Power Sources 174, 449-456 (2007), or International Pub. WO2013070298 or M. N. Obrovac and V. L. Chevrier, Chem. Rev., 114, 11444-11502 (2014), or U.S. Pat. App. Pub. 2007/0148544.

### SUMMARY

In some embodiments, an electrochemical cell is provided. The electrochemical cell includes a negative electrode that includes an active material including silicon. The electrochemical cell further includes a positive electrode that includes a first lithium metal oxide and a second lithium metal oxide. The first lithium metal oxide includes a material having (i) a nickel content of less than 30 mole %, based on the total moles of non-lithium metals in the first lithium metal oxide; and (ii) a D50 of greater than 2 micrometers. The second lithium metal oxide includes a material having (i) a nickel content of greater than 30 mole %, based on the total moles of non-lithium metals in the first lithium metal oxide; and (ii) a D50 of less than 2 micrometers. The second lithium metal oxide is provided in the positive electrode composition in an amount of less than 20 wt. %, based on the total weight of the first lithium metal oxide and second lithium metal oxide in the positive electrode composition.

In some embodiments, a method of forming an electrochemical cell is provided. The method includes providing a negative electrode including an active material including silicon. The method further includes providing a positive electrode including a first lithium metal oxide and a second lithium metal oxide. The first lithium metal oxide includes a material having (i) a nickel content of less than 30 mole %, based on the total moles of non-lithium metals in the first lithium metal oxide; and (ii) a D50 of greater than 2 micrometers. The second lithium metal oxide includes a material having (i) a nickel content of greater than 30 mole %, based on the total moles of non-lithium metals in the first lithium metal oxide; and (ii) a D50 of less than 2 micrometers. The second lithium metal oxide is provided in the positive electrode composition in an amount of less than 20 wt. %, based on the total weight of the first lithium metal oxide and second lithium metal oxide in the positive electrode composition.

The above summary is not intended to describe each disclosed embodiment of every implementation of the present disclosure. The brief description of the drawings and the detailed description which follows more particularly exemplify illustrative embodiments.

### BRIEF DESCRIPTION OF THE DRAWINGS

FIG. 1 shows a schematic cross-sectional view of an exemplary lithium ion battery (i.e., lithium ion electrochemical cell).

### DETAILED DESCRIPTION

Many of the performance issues associated with advanced lithium-ion batteries that include silicon or silicon containing materials in the negative electrode are the direct or indirect result of parasitic reactions at the surface of the silicon containing materials. Parasitic reactions occur primarily during cycling as the silicon containing material undergoes expansion and contraction. The expansion and contraction may compromise the integrity of passivation layers which may be present on the surface, and enable further parasitic reactions even after many cycles. Such reactions may result in reduced cycle life, capacity fade, gas generation (which can result in cell swelling or venting), impedance growth, and reduced rate capability.

It has been discovered that the presence of carbon dioxide gas mitigates the undesirable reactions that occur at the surface of a silicon containing negative electrode during cycling. However, the introduction of carbon dioxide gas into many types of electrochemical cells, e.g. pouch cells, is impractical due to ballooning of the cells. Ballooning may deform, break, or destroy the enclosure of the battery and result in the failure of the device. Ballooning may also lead to the loss of stack pressure and the resulting inhomogeneous current distribution may result in failure via Li-plating. Consequently, advanced-electrochemical cells that are configured to produce or contain a quantity of carbon dioxide gas sufficient to suppress the undesirable reactions at the surface of the silicon containing negative electrode, but yet low enough to avoid undesirable cell ballooning, are desirable.

As used herein,

the terms “lithiate” and “lithiation” refer to a process for adding lithium to an electrode material or electrochemically active phase;

the terms “delithiate” and “delithiation” refer to a process for removing lithium from an electrode material or electrochemically active phase;

the terms “charge” and “charging” refer to a process for providing electrochemical energy to a cell;

the terms “discharge” and “discharging” refer to a process for removing electrochemical energy from a cell, e.g., when using the cell to perform desired work;

the phrase “charge/discharge cycle” refers to a cycle wherein an electrochemical cell is fully charged, i.e. the cell attains its upper cutoff voltage and the cathode is at about 100% state of charge, and is subsequently discharged to attain a lower cutoff voltage and the cathode is at about 100% depth of discharge;

the phrase “positive electrode” refers to an electrode (often called a cathode) where electrochemical reduction and lithiation occurs during a discharging process in a full cell

the phrase “negative electrode” refers to an electrode (often called an anode) where electrochemical oxidation and delithiation occurs during a discharging process in a full cell;

the phrase “electrochemically active material” or “active material” refers to a material, which can include a single phase or a plurality of phases, that can electrochemically react or alloy with lithium under conditions possibly encountered during charging and discharging in a lithium ion battery;

the phrase “electrochemically inactive material” refers to a material, which can include a single phase or a plurality of phases, that does not electrochemically react or alloy with lithium under conditions possibly encountered during charging and discharging in a lithium ion battery;

the term “D50” refers to the median diameter of particles on a 50% by volume basis (i.e., the size that splits the volume distribution with half above and half below.) The D50 is commonly measured using laser diffraction techniques, which yield the complete particle size distribution (PSD). The D50 may also be estimated by calculating a volume distribution from scanning electron microscopy (SEM) images. Using SEM images to approximate a particle size distribution requires counting particles and estimating their diameter. At least 100 particles should be counted to obtain statistical significance.

the phrase “lithiation capacity” refers to the amount of lithium that can be electrochemically added to an electrochemically active material under conditions typically encountered during charging and discharging in a lithium ion battery;

the phrase “delithiation capacity” refers to the amount of lithium that can be electrochemically removed from an electrochemically active material under conditions typically encountered during charging and discharging in a lithium ion battery;

the phrase “irreversible capacity” for a negative electrode refers to the difference between the lithiation capacity obtained the first time the negative electrode is lithiated in an electrochemical cell and the delithiation capacity obtained the first time the negative electrode is delithiated in an electrochemical cell; for a positive electrode refers to the difference between the delithiation capacity obtained the first time the positive electrode is delithiated in an electrochemical cell and the lithiation capacity obtained the first time the positive electrode is lithiated in an electrochemical cell; and for a full cell refers to the difference between the charge capacity obtained the first time the full cell is charged and the discharge capacity obtained the first time the full cell is discharged;

the phrase “reversible capacity” for a negative electrode refers to the amount of lithium that can be electrochemically delithiated after complete lithiation; for a positive electrode refers to the amount of lithium that can be electrochemically lithiated after complete delithiation; for a full cell refers to the amount of lithium that can be discharged after a complete charge under conditions typically encountered during charging and discharging in a lithium ion battery;

the phrase “electrochemical half cell” refers to an electrode assembly wherein electrodes positioned at both ends of the assembly are stacked to form the cathode and anode, respectively, as shown in the structure of cathode/separator/anode or cathode/separator/anode/separator/cathode/separator/anode, and wherein the anode is lithium metal;

the phrase “electrochemical full cell” refers to an electrode assembly wherein electrodes positioned at both ends of the assembly are stacked to form the cathode and anode, respectively, as shown in the structure of cathode/separator/anode or cathode/separator/anode/separator/cathode/separator/anode, and wherein the anode is not lithium metal; and

the phrase “substantially homogeneous” refers to a material in which the components or domains of the material are sufficiently mixed with one another such that the make-up of one portion of the material is substantially the same as that of any other portion of the material.

As used herein, the singular forms “a”, “an”, and “the” include plural referents unless the content clearly dictates otherwise. As used in this specification and the appended embodiments, the term “or” is generally employed in its sense including “and/or” unless the content clearly dictates otherwise.

As used herein, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Generally, the present disclosure, in some embodiments, relates to electrochemical cells that are configured to contain or produce an amount of carbon dioxide within the cell during cycling sufficient to mitigate undesirable reactions at the surface of the electrodes, yet insufficient to cause undesirable ballooning.

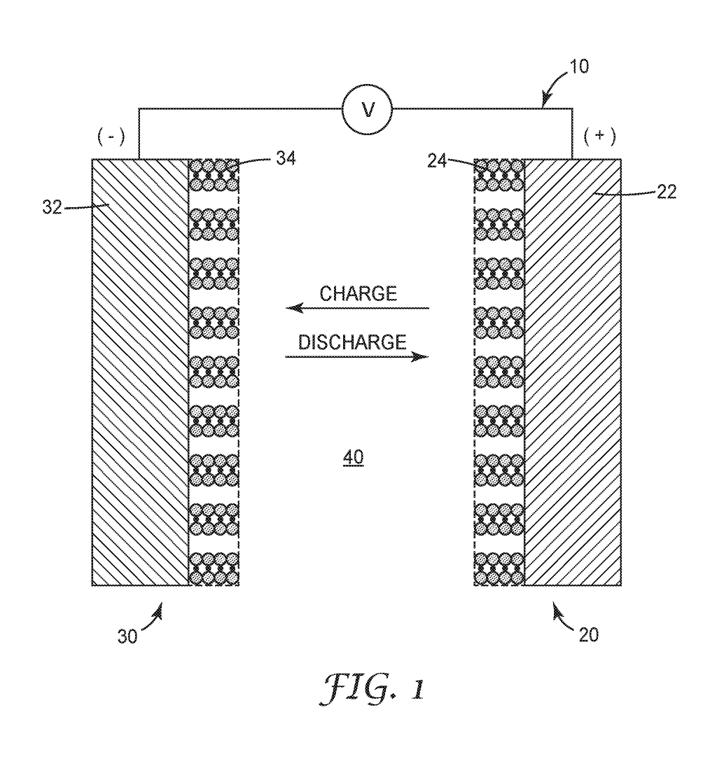

In some embodiments, the present disclosure provides a rechargeable electrochemical cell (e.g., a secondary lithium-ion battery) that includes a positive electrode, a negative electrode, and an electrolyte. FIG. 1 shows a schematic cross-sectional view of an electrochemical cell in accordance with some embodiments, In FIG. 1, 10 represents the external connections to the battery, 20 represents the positive electrode with an active material 24 coated onto a positive current collector 22, 30 represents the negative electrode with an active material 34 coated onto negative current collector 32, and 40 represents an electrolyte. Generally, during charging and discharging of the battery, lithium ions move, via the electrolyte, between the positive electrode 20 and the negative electrode 30. For example, when the battery is discharged, lithium ions flow from the negative electrode 30 to the positive electrode 20. In contrast, when the battery is charged, lithium ions flow from the positive electrode 20 to the negative electrode 30. The electrochemical cell may also include a separator (e.g., a polymeric microporous separator, not shown) provided intermediate or between the positive electrode 20 and the negative electrode 30. The electrodes 20 and 30 may be provided as relatively flat or planar plates or may be wrapped or wound in a spiral or other configuration (e.g., an oval configuration). For example, the electrodes may be wrapped around a relatively rectangular mandrel such that they form an oval wound coil for insertion into a relatively prismatic battery case. According to other exemplary embodiments, the battery may be provided as a button cell battery, a thin film solid state battery, or as any other electrochemical cell configuration. It is to be appreciated that FIG. 1 depicts only one example of a rechargeable electrochemical full cell arrangement and that, alternatively, any known electrochemical cell arrangement may be employed.

In some embodiments, the positive electrode may include a current collector having disposed thereon a positive electrode composition. The current collector for the positive electrode may be formed of a conductive material such as a metal. According to some embodiments, the current collector may include aluminum or an aluminum alloy. According to some embodiments, the thickness of the current collector may be 1 μm to 100 μm or 5 μm to 75 μm. It should also be noted that while the current collector for the positive electrode may be described as being a thin foil material, the positive current collector may have any of a variety of other configurations according to various exemplary embodiments. For example, the positive current collector may be a grid such as a mesh grid, an expanded metal grid, a photochemically etched grid, or the like.

In some embodiments, the positive electrode composition may include a first electrochemically active component and a second electrochemically active component. In some embodiments, the first and second electrochemically active component are not the same electrochemically active component. In some embodiments, either or both of the first and second electrochemically active components may include a lithium metal oxide. In some embodiments, the first electrochemically active component may include a first lithium metal oxide and the second electrochemically active component may include a second lithium metal oxide, the first and second lithium metal oxides being different lithium metal oxides.

In some embodiments, the first lithium metal oxide may include one of or any combination of cobalt, nickel, and manganese. In some embodiments, nickel may be present in the first lithium metal oxide in an amount of less than 33 mol %, less than 20 mol %, less than 10 mol %, less than 5 mol %, or less than 2 mol %, based on the total moles of non-lithium metals in the first lithium metal oxide. In some embodiments, the first lithium metal oxide does not include nickel. In some embodiments, the first lithium metal oxide may include or consist essentially of lithium cobalt oxide. In some embodiments, the first lithium metal oxide may have a D50 of greater than 2 μm, 4 μm, 5 μm, 8 μm, 10 μm, 15 μm, or 20 μm.

In some embodiments, the second lithium metal oxide may include nickel. In some embodiments, the second lithium metal oxide may include one of or any combination of cobalt, nickel, and manganese. In some embodiments, the second lithium metal oxide may include cobalt, nickel, and manganese. In some embodiments, the second lithium metal oxide may include one of or any combination of nickel, cobalt, and aluminum.

In some embodiments, nickel may be present in the second lithium metal oxide in an amount equal to or greater than 33 mol %, greater than 40 mol %, greater than 50 mol %, greater than 60 mol %, greater than 70 mol %, or greater than 80 mol %, based on the total moles of non-lithium metals in the second lithium metal oxide. In some embodiments, the second lithium metal oxide may have a D50 of less than 2 μm, less than 1 μm, less than 0.5 μm, less than 0.2 μm, or less than 0.1 μm.

In some embodiments, the second lithium metal oxide may include or consist of a material having the formula: Li(NiₓMn_{y}Co_{z})O₂, where x, y, and z represent atomic values, where x, y, and z are each greater than zero, where x+y+z=1, and where x is equal to or greater than 0.33, greater than 0.4, greater than 0.5, greater than 0.6 or greater than 0.8. In some embodiments, x is 0.58 to 0.62, y is 0.18 to 0.22, and z is 0.18 to 0.22. In some embodiments, x is 0.78 to 0.82, y is 0.08 to 0.12, and z is 0.08 to 0.12. This class of materials may be referred to as NMCs.

In some embodiments, the second lithium metal oxide may include or consist of a material having the formula: Li₁₊ₓ(NiₐMn_{b}Co_{c})₁₋ₓO₂, where a, b, and c represent atomic values, wherein 0.05≤x≤0.10, a+b+c=1, c/(a+b)<0.25, and a, b, and c are each greater than zero. In some embodiments b/a<1. In some embodiments b/a>1. In some embodiments, the second lithium metal oxide includes particles having a core with b/a<1 and a shell with b/a>1, such as those described in International Publication WO 2013070298, which is incorporated by reference herein in its entirety. This class of materials may be referred to as lithium-rich NMCs.

In some embodiments, the second lithium metal oxide may include or consist of a material having the formula Li₁₊ₓ(NiₐCo_{b}Al_{c})₁₋ₓO₂ where x>0, where a, b, and c represent atomic values, a, b, and c are each greater than zero, and a+b+c=1. In some embodiments, a is greater than 0.5, greater than 0.7, greater than 0.8, or greater than 0.9. This class of material may be referred to as NCA materials.

In some embodiments, the second lithium metal oxide may include or consist of a material having the formula: LiNiₓMn_{y}O₄, where x and y represent atomic values, where x and y are greater than zero, and where x+y=2. In some embodiments 0.45≤x≤0.55 and 1.45≤y≤1.55. This class of materials may be referred to as LMNO materials.

In some embodiments, the second lithium metal oxide may have a production surface. As used herein, for a given electrode stack area, a “production surface” refers to the surface area in (e.g., in m²) of the second lithium metal oxide present in the positive electrode composition, divided by the reversible capacity (e.g, in mAh) from a silicon containing negative electrode material present in in the corresponding negative electrode stack area. The units of the production surface may therefore be, m²/mAh, where the m² is from the second lithium metal oxide and the mAh are from the silicon containing material. In some embodiments, the production surface of the second lithium metal oxide may be greater than 0.001, greater than 0.002, greater than 0.003, greater than 0.005, greater than 0.01, or greater than 0.013 m²/mAh. In some embodiments, the production surface of the second lithium metal oxide may be less than 0.1, less than 0.05, less than 0.02, less than 0.015, or less than 0.010 m²/mAh. In some embodiments, the production surface of the second lithium metal oxide may be between 0.002 and 0.015, 0.005 and 0.014 or between 0.006 and 0.013 m²/mAh. It is believed that the production surface is a useful metric as it directly relates the surface at which the production of carbon dioxide occurs (the surface of the second lithium metal oxide), and the surface where ongoing carbon dioxide consumption occurs (the surface of the silicon containing material).

In some embodiments, the second lithium metal oxide may be provided in the positive electrode composition in an amount of at least 0.1 wt. %, at least 2 wt. %, or at least 10 wt. %; less than 20 wt. %, less than 10 wt. %, or less than 2 wt. %; or between 0.1 and 10 wt. %, between 2 and 10 wt. %, or between 1 and 5 wt. %, based on the total weight of the first lithium metal oxide and second lithium metal oxide in the positive electrode composition. In some embodiments, the second lithium metal oxide may be provided in the positive electrode composition in an amount of at least 0.1 wt. %, at least 2 wt. %, or at least 10 wt. %; less than 20 wt. %, less than 10 wt. %, or less than 2 wt. %; or between 0.1 and 10 wt. %, between 2 and 10 wt. %, or between 1 and 5 wt. %, based on the total weight of the positive electrode composition. In some embodiments, the first lithium metal oxide may be provided in the positive electrode composition in an amount of at least 50 wt. %, at least 80 wt. %, or at least 90 wt. %; less than 99 wt. %, less than 90 wt. %, or less than 80 wt. %; or between 80 and 99 wt. %, between 85 and 95 wt. %, or between 85 and 90 wt. %, based on the total weight of the positive electrode composition. For purposes of the present application, weight percentages of a component in an electrode composition are based on the dry electrode composition (i.e., with any solvent or electrolyte removed/evaporated).

In some embodiments, the second lithium metal oxide may be provided in an amount such that the second lithium metal oxide accounts for less than 20%, less than 10%, or less than 2%; or between 0.1% and 10%, between 2% and 10%, or between 1% and 5%, of the reversible capacity of the positive electrode composition.

In some embodiments, in addition to the materials described above, either or both of the first lithium metal oxide or the second lithium metal oxide, or the particles that comprise the first lithium metal oxide or the second lithium metal oxide, may include one or more coatings. Suitable coatings may include oxides, phosphates, fluorides, polymers and carbon, specific examples include alumina, titania, rare earth phosphates, lanthanum phosphate, lithium fluoride, carboxymethyl cellulose, and amorphous carbon. In some embodiments, the positive electrode composition may further include additives such as binders (e.g., polymeric binders (e.g., polyvinylidene fluoride)), conductive diluents (e.g., carbon), fillers, adhesion promoters, thickening agents for coating viscosity modification such as carboxymethylcellulose, or other additives known by those skilled in the art.

The positive electrode composition can be provided on only one side of the current collector or it may be provided or coated on both sides of the current collector. In some embodiments, the thickness of the positive electrode composition on the current collector may be 0.1 μm to 3 mm, 10 μm to 300 μm, or 20 μm to 90 μm.

In some embodiments, the positive electrode composition may include a first electrochemically active component and a second electrochemically inactive component, where the second electrochemically inactive component may promote the production of CO₂. In some embodiments, the second electrochemically inactive component may be a metal oxide. In some embodiments, suitable metal oxides may include one or any combination of Ni, V, Ti, Cr, or Mo. In some embodiments, V₂O₅/TiO₂ or MoO₃ is an oxidation catalyst as known by those familiar in the art, as described for example in J. C. Védrine et al., Comptes Rendus Chimie, 19, 1203-1225 (2016).

In some embodiments, the negative electrode may include a current collector having disposed thereon a negative electrode composition. The current collector for the negative electrode may be formed of a conductive material such as a metal. According to some embodiments, the current collector may include copper, a copper alloy, titanium, a titanium alloy, nickel, a nickel alloy, aluminum, or an aluminum alloy. According to some embodiments, the thickness of the current collector may be 1 μm to 100 μm or 5 μm to 75 μm. It should also be noted that while the negative current collector may be described as being a thin foil material, the negative current collector may have any of a variety of other configurations according to various exemplary embodiments. For example, the negative current collector may be a grid such as a mesh grid, an expanded metal grid, a photochemically etched grid, or the like.

In some embodiments, the negative electrode composition may include an active material that includes silicon. For example, suitable silicon containing active materials include elemental silicon, silicon oxides, silicon carbides, or silicon alloys. In some embodiments, silicon containing active materials may be present in the negative electrode compositions in an amount of at least 5 wt. %, at least 10 wt. %, or at least 30 wt. %; less than 60 wt. %, less than 30 wt. %, or less than 10 wt. %; or between 5 and 60 wt. %, between 5 and 30 wt. %, or between 10 and 30 wt. %, based on the total weight of the negative electrode compositions.

In some embodiments, the active material of the negative electrode may include a silicon alloy. For example, the active material of the negative electrode may include a silicon alloy that includes silicon, one or more transition metals, and carbon. In yet another example, the active material of the negative electrode may include a silicon alloy material having the formula II:

Si_{w}M¹ₓC_{y} (II)

where w, x, y, and z represent atomic % values and w+x+y+z=100; M¹ is one or more transition metals; and w>0, x>0, y≥0. In some embodiments M¹ may include one or more of Mg, Al, Ti, V, Cr, Mn, Fe, Co, Ni, Cu, Zn, Zr, B or Ti, B, Mg, V, Fe, Mn, Co, Ni, Cu. In some embodiments, M¹ may include iron. In some embodiments w may be between 50% and 90%, 65% and 85%, 70% and 80%, or 72% and 77%; x may be between 5% and 20%, 12% and 20%, or 14% and 18%; y may be between 2% and 15%, 5% and 12%, or 8% and 12%. In some embodiments, the silicon alloy material may be described as one or more active phases and one or more inactive phases. In some embodiments, silicon alloy material of formula II may further include oxygen.

In some embodiments, the active material of the negative electrode may include a silicon suboxide. For example, the active material of the negative electrode may include a material having the formula: SiOₓ where 0.5≤x≤0.9. As an additional example, the active material of the negative electrode may include a material having the formula: SiₓM_{y}O_{z}, where M may include one or more of Mg, Al, Ti, V, Cr, Mn, Fe, Co, Ni, Cu, Zn, Zr, B; or Ti, B, Mg, V, Fe, Mn, Co, Ni, Cu; x, y, z are each greater than zero, and x>2y+z.

In some embodiments, in addition to or as an alternative to the silicon containing material, the negative electrode may include lithium metal, or an element which alloys with lithium, such as magnesium, zinc, boron, aluminum, gallium, indium, carbon, germanium, tin, lead, antimony, or bismuth.

In some embodiments, the negative electrode compositions may further include graphite. Graphite may be present in the negative electrode compositions in an amount of greater than 10 wt. %, greater than 20 wt. %, greater than 50 wt. %, greater than 70 wt. % or even greater, based upon the total weight of the negative electrode composition; or between 20 wt. % and 90 wt. %, between 30 wt. % and 80 wt. %, between 40 wt. % and 60 wt. %, between 45 wt. % and 55 wt. %, between 80 wt. % and 90 wt. %, or between 85 wt. % and 90 wt. %, based upon the total weight of the negative electrode composition.

In some embodiments, the negative electrode composition may further include additives such as binders (e.g., polymeric binders (e.g., polyvinylidene fluoride or styrene butadiene rubber (SBR), lithium polyacrylate, sodium polyacrylate, polyimides, aromatic polyimides, resins, phenolic resins), conductive diluents (e.g., carbon black and/or carbon nanotubes), fillers, adhesion promoters, thickening agents for coating viscosity modification such as carboxymethylcellulose, or other additives known by those skilled in the art.

In various embodiments, the negative electrode composition can be provided on only one side of the negative current collector or it may be provided or coated on both sides of the current collector. The thickness of the negative electrode composition may be 0.1 μm to 3 mm, 10 μm to 300 μm, or 20 μm to 90 μm.

In various embodiments, the electrolyte may include one or more solvents. In some embodiments, the electrolyte solvent may be selected to maximize solubility of carbon dioxide. According to “Hansen Solubility Parameters: A User's Handbook, Charles M. Hansen, 2007”, carbon dioxide is nearly twice as soluble in acetates as compared to carbonates. In some embodiments, the electrolyte solvent may include one or more acetates such as, for example, ethyl acetate, propyl acetate, methyl acetate. Acetates may be present in the electrolyte solvent in an amount of between 5 wt. % and 90 wt. %, between 5 wt. % and 70 wt. %, between 5 wt. % and 50 wt. %, or between 10 wt. % and 30 wt. %, based on the total weight of solvent in the electrolyte. Additionally, or alternatively, the solvent may include one or more organic carbonates such as, for example, ethylene carbonate, diethyl carbonate, dimethyl carbonate, ethyl methyl carbonate, vinylene carbonate, propylene carbonate, or fluoroethylene carbonate. In some embodiments, the solvent may include either or both of fluoroethylene carbonate and vinylene carbonate, which are known to enhance the production of carbon dioxide.

In some embodiments, solvent may be present in the electrolyte in an amount of between 15 and 98 wt. %, between 25 and 95 wt. %, between 50 and 90 wt. %, or between 70 and 90 wt. %, based on the total weight of the electrolyte.

In some embodiments, the electrolyte may include one or more electrolyte salts. In some embodiments, the electrolyte salts may include lithium salts and, optionally, other salts such as sodium salts (e.g., NaPF₆). Suitable lithium salts may include LiPF₆, LiBF₄, LiClO₄, lithium bis(oxalato)borate, LiN(SO₂CF₃)₂, LiN(SO₂C₂F₅)₂, LiAsF₆, LiC(SO₂CF₃)₃, LiN(SO₂F)₂, LiN(SO₂F)(SO₂CF₃), LiN(SO₂F)(SO₂C₄F₉), or combinations thereof. In some embodiments, the lithium salts may include LiPF₆, lithium bis(oxalato)borate, LiN(SO₂CF₃)₂, or combinations thereof. In some embodiments, the lithium salts may include LiPF₆ and either or both of lithium bis(oxalato)borate and LiN(SO₂CF₃)₂. The electrolyte salts may be present in the electrolyte solution in an amount of between 2 and 85 wt %, between 5 and 75 wt %, between 10 and 50 wt %, or between 10 and 30 wt %, based on the total weight of the electrolyte.

In some embodiments, the electrolyte solutions of the present disclosure may also include one or more electrolyte additives such as any one of or any combination of, for example, vinylene carbonate (VC), propane-1,3-sultone (PS), prop-1-ene-1,3-sultone (PES), succinonitrile (SN), 1,5,2,4-dioxadithiane-2,2,4,4-tetraoxide (MMDS), lithium bis(oxalate)borate (LiBOB), lithium difluoro(oxalato)borate (LiDFOB), tris(trimethylsilyl)phosphite (TTSPi), ethylene sulfite (ES), 1,3,2-dioxathiolan-2,2-oxide (DTD), vinyl ethylene carbonate(VEC), trimethylene sulfite (TMS), tri-allyl-phosphate (TAP), methyl phenyl carbonate (MPC), diphenyl carbonate (DPC), ethyl phenyl carbonate (EPC), and tris(trimethylsilyl)phosphate (TTSP). The additional electrolyte additives may be present, individually or in combination, in an amount of between 0.1 and 5 wt. %, between 0.5 and 5 wt. %, between 1 and 5 wt. %, or between 1 and 3 wt. %, based on the total weight of the electrolyte.

In some embodiments, the electrolyte may further include one or more additives known to produce carbon dioxide in a lithium-ion cell such as, for example, linear pyrocarbonates (diethylprocarbonate, dimethylpyrocarbonate, ethyl methyl pyrocarbonate). The carbon dioxide producing additives may be present, individually or in combination, in an amount of between 0.1 and 10 wt. %, between 0.5 and 7 wt. %, between 1 and 5 wt. %, or between 1 and 3 wt. %, based on the total weight of the electrolyte.

Additionally, or alternatively, carbon dioxide may be added directly to the electrochemical cell via the saturation of the electrolyte with carbon dioxide or the addition of solid state carbon dioxide before sealing the electrochemical cell.

In some embodiments, the electrochemical cells of the present disclosure may include a separator (e.g., a polymeric microporous separator which may or may not be coated with a layer of inorganic particles such as Al₂O₃) provided intermediate or between the positive electrode and the negative electrode. The electrodes may be provided as relatively flat or planar plates or may be wrapped or wound in a spiral or other configuration (e.g., an oval configuration). For example, the electrodes may be wrapped around a relatively rectangular mandrel such that they form an oval wound coil for insertion into a relatively prismatic battery case. According to other exemplary embodiments, the battery may be provided as a button cell battery, a thin film solid state battery, or as another lithium ion battery configuration.

According to some embodiments, the separator can be a polymeric material such as a polypropylene/polyethylene copolymer or another polyolefin multilayer laminate that includes micropores formed therein to allow electrolyte and lithium ions to flow from one side of the separator to the other. The thickness of the separator may be between approximately 6 micrometers (μm) and 50 μm according to an exemplary embodiment. The average pore size of the separator may be between approximately 0.02 μm and 0.1 μm.

In some embodiments, the present disclosure is further directed to electrochemical cells (e.g., lithium-ion batteries) that include the above-described positive electrodes, negative electrodes, and electrolytes.

In some embodiments, the present disclosure is further directed to electronic devices that include the above-described electrochemical cells. For example, the disclosed electrochemical cells can be used in a variety of devices including, without limitation, portable computers, tablet displays, personal digital assistants, mobile telephones, motorized devices (e.g., personal or household appliances and vehicles), power tools, illumination devices, and heating devices.

The present disclosure further relates to methods of making an electrochemical cell. In various embodiments, the method may include providing the above-described negative electrode, providing the above-described positive electrode, and incorporating the negative electrode and the positive electrode into a battery comprising the above-described electrolyte.

### Listing of Embodiments

1. An electrochemical cell comprising:
   a negative electrode comprising an active material comprising silicon; and
   a positive electrode comprising a first lithium metal oxide and a second lithium metal oxide;
   wherein the first lithium metal oxide comprises a material having (i) a nickel content of less than 30 mole %, based on the total moles of non-lithium metals in the first lithium metal oxide; and (ii) a D50 of greater than 2 micrometers;
   wherein the second lithium metal oxide comprises a material having (i) a nickel content of greater than 30 mole %, based on the total moles of non-lithium metals in the first lithium metal oxide; and (ii) a D50 of less than 2 micrometers; and
   wherein the second lithium metal oxide is provided in the positive electrode composition in an amount of less than 20 wt. %, based on the total weight of the first lithium metal oxide and second lithium metal oxide in the positive electrode composition.
2. The electrochemical cell of embodiment 1, wherein the first lithium metal oxide comprises lithium cobalt oxide.
3. The electrochemical cell of any one of the previous embodiments, wherein the second lithium metal oxide comprises a material having a formula: Li(NiₓMn_{y}Co_{z})O₂, where x, y, and z are greater than zero, x+y+z=1, and x is greater than 0.33.
4. The electrochemical cell of embodiment 3, wherein x is 0.58-0.62, y is 0.18-0.22, and z is 0.18-0.22.
5. The electrochemical cell of embodiment 3, wherein x is 0.78-0.82, y is 0.08-0.12, and z is 0.08-0.12.
6. The electrochemical cell of any one of the previous embodiments, wherein x is equal to or greater than 0.6.
7. The electrochemical cell of any one of the previous embodiments, wherein the second lithium metal oxide comprises a material having a formula:
   Li_{1+x′}(NiₐMn_{b}Co_{c})_{1-x′}O₂, wherein 0.05≤x′≤0.10, a+b+c=1, c/(a+b)<0.25, a>0.30, and a, b and c are each greater than zero.
8. The electrochemical cell of any one of the previous embodiments, wherein the second lithium metal oxide comprises a material having a formula:
   Li_{1+x″}(NiₐCo_{b}Al_{c})_{1-x″}O₂, where x″≥0, and a, b, and c are each greater than zero, a+b+c=1 and a>0.7.
9. The electrochemical cell of any one of the previous embodiments, wherein the first lithium metal oxide comprises a material having a D50 greater than 5 micrometers and the second lithium metal oxide comprises a material having a D50 less than 1 micrometer.
10. The electrochemical cell of any one of the previous embodiments, wherein the second lithium metal oxide is provided in an amount such that the second lithium metal oxide accounts for less than 10% of the reversible capacity of the positive electrode composition.
11. The electrochemical cell of any one of the previous embodiments, wherein the active material comprising silicon comprises a silicon alloy comprising a transition metal, a silicon carbide, or a silicon oxide.
12. The electrochemical cell of any one of the previous embodiments, wherein a production surface of the second lithium metal oxide is greater than 0.003 m2/mAh and less than 0.015 m2/mAh.
13. An electrochemical cell comprising:
   a negative electrode comprising an active material comprising silicon; and
   a positive electrode comprising a first lithium metal oxide and a second lithium metal oxide;
   wherein the first lithium metal oxide comprises a material having (i) a nickel content of less than 30 mole %, based on the total moles of non-lithium metals in the first lithium metal oxide; and (ii) a D50 of greater than 2 micrometers;
   wherein the second lithium metal oxide comprises a material having (i) a nickel content of greater than 30 mole %, based on the total moles of non-lithium metals in the first lithium metal oxide; and (ii) a D50 of less than 2 micrometers; and
   wherein a production surface of the second lithium metal oxide is greater than 0.003 m2/mAh and less than 0.015 m2/mAh.
14. The electrochemical cell of any of the previous embodiments, further comprising an electrolyte comprising an acetate.
15. A method of forming an electrochemical cell comprising:
   providing a negative electrode comprising an active material comprising silicon; and
   providing a positive electrode comprising a first lithium metal oxide and a second lithium metal oxide;
   wherein the first lithium metal oxide comprises a material having (i) a nickel content of less than 30 mole %, based on the total moles of non-lithium metals in the first lithium metal oxide; and (ii) a D50 of greater than 2 micrometers;
   wherein the second lithium metal oxide comprises a material having (i) a nickel content of greater than 30 mole %, based on the total moles of non-lithium metals in the first lithium metal oxide; and (ii) a D50 of less than 2 micrometers; and
   wherein the second lithium metal oxide is provided in the positive electrode composition in an amount of less than 20 wt. %, based on the total weight of the first lithium metal oxide and second lithium metal oxide in the positive electrode composition.

### Examples

The following examples are offered to aid in the understanding of the present disclosure and are not to be construed as limiting the scope thereof. Unless otherwise indicated, all parts and percentages are provided on a weight basis.

### Lithium Metal Oxides

Cathode material HX12Th (Umicore, Belgium), having the nominal composition Li(Ni_{0.6}Mn_{0.2}Co_{0.2})O₂ (NMC622) was mixed with N-Methyl-2-pyrrolidone (NMP) in a 1:1 weight ratio. Two kilograms of the mixture were then bead milled using Netzsch Lab Star (Netzsch, Germany) in a 700 mL chamber filled with 0.5 mm Y-stabilized zirconia beads. The mill rotor had a speed of 3000 RPM and the flow rate of the mixture was 150 mL/min. The mill was operated in recirculating mode.

Table 1 shows the median particle size (D50) of the powder as a function of milling time as measured using a HORIBA LA-950 laser particle size analyzer (HORIBA, Japan). Particle size measurements were performed in water with 1 minute of sonication prior to measurement. The median size of the HX12Th powder as purchased was 9.8 μm.

TABLE 1
Median particle diameter (D50) as a function of milling time

| Milling Time | D50 |
|---|---|
| (minutes) | (microns) |
| 0 | 9.80 |
| 9 | 1.26 |
| 27 | 0.83 |
| 36 | 0.66 |
| 45 | 0.57 |
| 54 | 0.55 |
| 63 | 0.49 |
| 72 | 0.47 |

Table 2 lists the properties of NMC622 lithium metal oxide powders obtained by milling as described above, having various median sizes and surface areas. Surface areas were measured using a Quantachrome NOVA surface area analyzer (Quantachrome Instruments, Boynton Beach, Fla., USA). The surface area of the HX12Th powder as purchased was measured to be 0.23 m²/g.

TABLE 2
Median sizes and surface areas of Lithium Metal Oxides

| Example | D50 (μm) | Surface Area (m²/g) |
|---|---|---|
| HX12Th | 9.80 | 0.23 |
| Example 1 | 1.66 | 3.11 |
| Example 2 | 0.86 | 6.48 |
| Example 3 | 0.61 | 9.95 |
| Example 4 | 0.47 | 11.84 |

### Preparation of Electrodes and Electrochemical Cells

Example 4, which will also be referred to as high surface area NMC (HSNMC), was used to make slurries and subsequent cathode coatings. Table 3 lists the materials used to make electrodes. Silicon alloy composite particles having the formula Si₇₅Fe₁₄C₁₁ were prepared using procedures disclosed in U.S. Pat. Nos. 8,071,238 and 7,906,238, after which the alloy particles were coated with nano-carbon and flake graphite. Tables 4A and 4B list cathode compositions for Comparative Examples CE1 and CE2, and for Examples 5-9, respectively.

TABLE 3
Materials used to make electrodes

| ID | Material | Vendor |
|---|---|---|
| HX12Th | Li(Ni_{0.6}Mn_{0.2}Co_{0.2})O₂ | Umicore, Belgium |
| UX20P | LiCoO₂ | Umicore, Belgium |
| PVDF | Polyvinylidene fluoride | Arkema, France |
| LiPAA | Lithium polyacrylate | Sigma Aldrich, St. Louis, MO, |
| | | US |
| SP | Super P | Imerys, France |
| KS6L | Synthetic flake graphite | Imerys, France |
| BTR 918II | Synthetic graphite | BTR New Energy Materials, |
| | | China |

TABLE 4A
Cathode compositions of Comparative Examples

| | LCO | NMC622 | | | |
|---|---|---|---|---|---|
| | (UX20P) | (HX12Th) | KS6 | SP | PVDF |
| CE1 | 92% | 2% | 1.25% | 1.25% | 3.5% |
| CE2 | 94% | 0% | 1.25% | 1.25% | 3.5% |

TABLE 4B
Cathode compositions of Illustrative Examples

| | LCO (UX20P) | HSNMC | KS6 | SP | PVDF |
|---|---|---|---|---|---|
| Example 5 | 93.5% | 0.5% | 1.25% | 1.25% | 3.5% |
| Example 6 | 93.0% | 1.0% | 1.25% | 1.25% | 3.5% |
| Example 7 | 92.0% | 2.0% | 1.25% | 1.25% | 3.5% |
| Example 8 | 90.0% | 4.0% | 1.25% | 1.25% | 3.5% |
| Example 9 | 86.0% | 8.0% | 1.25% | 1.25% | 3.5% |

The slurries having compositions listed in Tables 4A and 4B were mixed in a THINKY ARE-310 planetary centrifugal mixer (THINKY, Japan) and coated at 16 mg/cm² single sided on 20 μm Al foil with a HIRANO coating machine (HIRANO TECSEED, Japan). Dried electrodes were then calendered to a thickness of 70 μm.

A negative electrode with composition 20% Si alloy/72% BTR-918II/3% KS6L/1% SP/4% LiPAA by weight was coated with a HIRANO coater at 6.6 mg/cm² single sided on 18 μm Cu foil and calendered to 70 μm.

Single layer pouch (SLP) electrochemical cells were assembled by pairing Comparative Examples CE1 and CE2 and Examples 5-9 with the above anode. Two cells were assembled for each pouch cell. The cathode and anode were separated by a CELGARD 2325 separator (CELGARD, Charlotte, N.C., US) and enclosed in an aluminized pouch. The SLPs were assembled in a dry room with a dew point of −40° C. or less and vacuum dried at 80° C. for 24 hrs. They were then filled with 0.48 g of LP57 electrolyte (BASF, Germany) which consists of 3/7 w/w ethylene carbonate (EC)/ethyl methyl carbonate (EMC) in 1M LiPF₆. After filling, the cells were vacuumed to induce wetting, then vacuum sealed using a MSK-115 vacuum sealer (MTI Corp., US). After vacuum sealing the cells were held at 2V for 24 hrs.

### Testing of Electrochemical Cells

After the 24-hour 2V hold, the cells were weighed dry and submerged in water in order to determine their volume via the Archimedes technique, where the cell volume, V, is obtained from V=−Δm/ρ, where Δm is the difference between the submerged weight and the dry weight, and p is the density of the liquid. All cells had a nominal volume of 2 ml. The cells were then placed in a temperature controlled chamber at 30° C. and underwent a formation cycle using a NOVONIX High Precision Cycler (NOVONIX, Canada) by charging the cells to 4.35 V and discharging them to 2.75 Vat 1.8 mA. The cells had a nominal reversible capacity of 30 mAh and a nominal areal capacity of 2.5 mAh/cm².

After the formation cycle, the cell volumes were once more measured by the Archimedes method and returned to the 30° C. chamber on the NOVONIX cycler for further cycling. The cells were cycled by charging to 4.25V at 15 mA then to 4.35 V at 1.5 mA followed by a discharge to 2.75 V at 15 mA.

Table 5 lists the electrochemical properties of the cycled cells including the charge and discharge capacities on the formation cycle, the first cycle efficiency (FCE), the Coulombic efficiency (CE) at cycle 20, and the volume change that occurred on formation. Two cells were tested for each example.

TABLE 5
Results of electrochemical cycling tests

| | | Charge | Discharge | | CE at | Volume |
|---|---|---|---|---|---|---|
| | | Capacity | Capacity | | Cycle | change |
| | Cell ID | (mAh) | (mAh) | FCE | 20 | (mL) |
| CE 1 | 38094p1a | 34.1 | 30.7 | 90.2% | 0.9933 | −0.02 |
| | 38094p2a | 34.0 | 30.7 | 90.2% | 0.9937 | −0.06 |
| CE 2 | 38095p1a | 33.5 | 30.3 | 90.4% | 0.9938 | −0.03 |
| | 38095p2a | 33.3 | 30.1 | 90.4% | 0.9937 | 0.00 |
| Exam- | 38096p1a | 33.1 | 29.9 | 90.2% | 0.9941 | −0.05 |
| ple 5 | 38096p2a | 32.9 | 29.7 | 90.2% | 0.9945 | 0.07 |
| Exam- | 38104p1a | 33.2 | 30.1 | 90.4% | 0.9954 | −0.15 |
| ple 6 | 38104p2a | 33.2 | 30.0 | 90.4% | 0.9952 | 0.02 |
| Exam- | 38105p1a | 33.4 | 30.1 | 90.0% | 0.9959 | 0.03 |
| ple 7 | 38105p2a | 34.1 | 30.7 | 90.2% | 0.9957 | 0.12 |
| Exam- | 38124p1a | 34.1 | 30.8 | 90.3% | 0.9963 | −0.06 |
| ple 8 | 38124p2a | 34.2 | 30.9 | 90.3% | 0.9962 | 0.06 |
| Exam- | 38125p1a | 31.9 | 28.5 | 89.3% | 0.9965 | −0.12 |
| ple 9 | 38125p2a | 30.9 | 27.5 | 89.1% | 0.9970 | 0.01 |

From Table 5, it is evident that the addition of HSNMC had a negligible effect on the volume changes of the cells. For Examples 5, 6, 7, and 8 the addition of HSNMC had negligible effect on charge and discharge capacities and FCE values. Surprisingly, the CE efficiencies and capacity retention of all cells prepared with the HSNMC (Examples 5-9) were superior (>0.994) to the comparative examples (<0.994).

### Cathode Production Surface

A negative electrode with composition 20% Si alloy/72% BTR-9181I/3% KS6L/1% SP/4% LiPAA by weight was coated with a Hirano coater at 6.6 mg/cm2 single sided on 18 μm Cu foil and calendered to 70 μm. The Si alloy and graphite represent approximately 45% and 55% of the capacity of the negative electrode, respectively. The positive electrode had a gravimetric capacity of approximately 165 mAh/g, and a loading of 16 mg/cm² based on data presented previously. The HSNMC had a surface area of 11.84 m²/g (see Table 1). Based on these figures, the amount of HSNMC surface area per mAh of Si capacity can be calculated. Results of these calculations are listed in Table 6. This normalized area is referred to as the “production surface,” S_{prod}, with units of m²/mAh.

TABLE 6
HSNMC surface area per mAh of Si capacity

| | | Absolute | | | |
|---|---|---|---|---|---|
| | | Area of | Si-based | Production | Average |
| | HSNMC | HSNMC | capacity | Surface | CE at cycle |
| | (wt %) | (m²) | (mAh) | (m²/mAh) | 20 |
| CE1 | 0 | 0 | 13.5 | 0 | 0.9935 |
| CE 2 | 0 | 0 | 13.5 | 0 | 0.9937 |
| Example 5 | 0.5 | 0.011 | 13.5 | 0.0008 | 0.9943 |
| Example 6 | 1.0 | 0.022 | 13.5 | 0.0016 | 0.9953 |
| Example 7 | 2.0 | 0.043 | 13.5 | 0.0032 | 0.9958 |
| Example 8 | 4.0 | 0.086 | 13.5 | 0.0064 | 0.9962 |
| Example 9 | 8.0 | 0.172 | 13.5 | 0.0128 | 0.9968 |

For purposes of the present application, the production surface can be determined from the D50 of the lithium metal oxide particles, which are readily viewed in a Scanning Electron Micrograph of a cross section of an electrode.

The production surface is defined as:

S_{prod}=(6ξ×γ/(D50×ρ×c×α) Equation 1

where D50 is the median particle diameter in microns of the second material responsible for CO₂ production, ρ is its density in g/cm³, ξ is a factor accounting for the non-spherical particle shape, c is the gravimetric capacity of the cathode in mAh/g, γ is the weight percent of the second material in the cathode, and α is the fraction of the capacity provided by the alloying element, e.g. Si, in the anode. A common range for ξ would be less than 8 and more than 1, or less than 5 and more than 2. In the case of Examples 5-9 it is more than 4 and less than 5. If ξ is unknown, it can be approximated as 4.

Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows. All references cited in this disclosure are herein incorporated by reference in their entirety.

What is claimed is:

1. An electrochemical cell comprising:
a negative electrode comprising an active material comprising silicon; and
a positive electrode comprising a first lithium metal oxide and a second lithium metal oxide;
wherein the first lithium metal oxide comprises a material having (i) a nickel content of less than 30 mole %, based on the total moles of non-lithium metals in the first lithium metal oxide; and (ii) a D50 of greater than 2 micrometers;
wherein the second lithium metal oxide comprises a material having (i) a nickel content of greater than 30 mole %, based on the total moles of non-lithium metals in the first lithium metal oxide; and (ii) a D50 of less than 2 micrometers; and
wherein the second lithium metal oxide is provided in the positive electrode composition in an amount of less than 20 wt. %, based on the total weight of the first lithium metal oxide and second lithium metal oxide in the positive electrode composition.

2. The electrochemical cell of claim 1, wherein the first lithium metal oxide comprises lithium cobalt oxide.

3. The electrochemical cell of claim 1, wherein the second lithium metal oxide comprises a material having a formula: Li(NiₓMn_{y}Co_{z})O₂, where x, y, and z are greater than zero, x+y+z=1, and x is greater than 0.33.

4. The electrochemical cell of claim 3, wherein x is 0.58-0.62, y is 0.18-0.22, and z is 0.18-0.22.

5. The electrochemical cell of claim 3, wherein x is 0.78-0.82, y is 0.08-0.12, and z is 0.08-0.12.

6. The electrochemical cell of claim 3, wherein x is equal to or greater than 0.6.

7. The electrochemical cell of claim 1, wherein the second lithium metal oxide comprises a material having a formula: Li_{1+x′}(NiₐMn_{b}Co_{c})_{1-x′}O₂, wherein 0.05≤x′≤0.10, a+b+c=1, c/(a+b)<0.25, a>0.30, and a, b and c are each greater than zero.

8. The electrochemical cell of claim 1, wherein the second lithium metal oxide comprises a material having a formula: Li_{1+x′}(NiₐCo_{b}Al_{c})_{1-x″}O₂, where x″≥0, and a, b, and c are each greater than zero, a+b+c=1 and a>0.7.

9. The electrochemical cell of claim 1, wherein the first lithium metal oxide comprises a material having a D50 greater than 5 micrometers and the second lithium metal oxide comprises a material having a D50 less than 1 micrometer.

10. The electrochemical cell of claim 1, wherein the second lithium metal oxide is provided in an amount such that the second lithium metal oxide accounts for less than 10% of the reversible capacity of the positive electrode composition.

11. The electrochemical cell of claim 1, wherein the active material comprising silicon comprises a silicon alloy comprising a transition metal, a silicon carbide, or a silicon oxide.

12. The electrochemical cell of claim 1, wherein a production surface of the second lithium metal oxide is greater than 0.003 m2/mAh and less than 0.015 m2/mAh.

13. An electrochemical cell comprising:
a negative electrode comprising an active material comprising silicon; and
a positive electrode comprising a first lithium metal oxide and a second lithium metal oxide;
wherein the first lithium metal oxide comprises a material having (i) a nickel content of less than 30 mole %, based on the total moles of non-lithium metals in the first lithium metal oxide; and (ii) a D50 of greater than 2 micrometers;
wherein the second lithium metal oxide comprises a material having (i) a nickel content of greater than 30 mole %, based on the total moles of non-lithium metals in the first lithium metal oxide; and (ii) a D50 of less than 2 micrometers; and
wherein a production surface of the second lithium metal oxide is greater than 0.003 m2/mAh and less than 0.015 m2/mAh.

14. The electrochemical cell of claim 1, further comprising an electrolyte comprising an acetate.

15. The electrochemical cell of claim 13, further comprising an electrolyte comprising an acetate.

16. The electrochemical cell of claim 1, further comprising a carbon dioxide producing additive.

17. The electrochemical cell of claim 1, further comprising an electrolyte comprising a linear pyrocarbonate.

18. A method of forming an electrochemical cell comprising:
providing a negative electrode comprising an active material comprising silicon; and
providing a positive electrode comprising a first lithium metal oxide and a second lithium metal oxide;
wherein the first lithium metal oxide comprises a material having (i) a nickel content of less than 30 mole %, based on the total moles of non-lithium metals in the first lithium metal oxide; and (ii) a D50 of greater than 2 micrometers;
wherein the second lithium metal oxide comprises a material having (i) a nickel content of greater than 30 mole %, based on the total moles of non-lithium metals in the first lithium metal oxide; and (ii) a D50 of less than 2 micrometers; and
wherein the second lithium metal oxide is provided in the positive electrode composition in an amount of less than 20 wt. %, based on the total weight of the first lithium metal oxide and second lithium metal oxide in the positive electrode composition.
